(19) United States
(12) Patent Application Publication
(10) Pub. No.: US 2011/0274954 A1
(43) Pub. Date: Nov. 10, 2011

(54) THREAD-TYPE BATTERY AND CONNECTOR FOR CONNECTING SAME

(75) Inventors: Gyu-Bong Cho, Gyeongsangnam-do (KR); Kwon-Koo Cho, Gyeongsangnam-do (KR); Tae-Hyeon Nam, Gyeongsangnam-do (KR); Hyo-Jun Ahn, Gyeongsangnam-do (KR); Ki-Won Kim, Gyeongsangnam-do (KR); Jou-Hyeon Ahn, Gyeongsangnam-do (KR)

(73) Assignee: Industry-Academic Cooperation Foundation Gyeongsang National University, Gyeongsangnam-do (KR)

(21) Appl. No.: 13/142,826

(22) PCT Filed: Nov. 25, 2009
(86) PCT No.: PCT/KR2009/006989

§ 371 Date: Jun. 29, 2011

(30) Foreign Application Priority Data
Dec. 29, 2008 (KR) 10-2008-0135713

(51) Int. Cl. H01M 10/36; H01R 4/30; H01M 10/02

(52) U.S. Cl. 429/94; 429/127; 439/755

(57) ABSTRACT

Disclosed is a thread-type battery. The battery of the present invention comprises a flexible body unit, a first pole terminal which is formed at one end of the body unit, and which protrudes so as to be insertable into a first external terminal, and a second pole terminal which is formed at the other end of the body unit which has a shape in which a second external terminal is to be inserted, and which has a polarity opposite that of the first pole terminal. The present invention enables users to easily connect positive poles and negative poles.

### CROSS-REFERENCE TO RELATED APPLICATION

This application is a National Stage of International Application No. PCT/KR2009/006989, filed Nov. 25, 2009, and claims priority from Korean Patent Application No. 2008-135713 filed on Dec. 29, 2008 in the Korean Intellectual Property Office, the disclosure of which is incorporated herein in its entirety by reference.

### FIELD OF THE INVENTION

Systems and methods consistent with the present invention relate to a thread-type battery and a connector for connecting the same, and more particularly, to a thread-type battery which comprises a first pole terminal and a second pole terminal which are distinguished from each other in their forms, and a connector for connecting the same.

### BACKGROUND OF THE INVENTION

Thanks to the development of electronic technologies, diverse electronic devices have been developed and widely used. The electronic devices essentially use electric energy. Therefore, batteries of various forms suitable for various sizes and forms of the electronic devices have been increasingly needed.

Accordingly, an effort to develop a battery having flexibility has been made. In other words, an effort to develop a battery of a flexible form, which can be bent or curved, other than an existing battery of a fixed form such as a cylinder type battery, a cube type battery, and a coin type battery, has been made.

As part of this effort, a thread-type battery has been developed. However, the thread-type battery is too thin and long to distinguish between a positive pole terminal and a negative pole terminal, and also, it is difficult to connect the batteries in series or in parallel.

### SUMMARY

An exemplary embodiment of the present invention provides a thread-type battery which comprises opposite pole terminals which are distinguished from each other, and a connector for connecting the same.

According to an aspect of the present invention, there is provided a thread-type battery comprising a flexible body unit, a first pole terminal which is formed at one end of the body unit and protrudes so as to be insertable into a first external terminal, and a second pole terminal which is formed at the other end of the body unit and has a shape in which a second external terminal is to be inserted, and which has an polarity opposite a polarity of the first pole terminal.

The first pole terminal may have at least one convexo-concave portion formed thereon.

The second pole terminal may have a shape in which a second terminal corresponding to the first pole terminal in shape is to be inserted.

The body unit may comprise an internal current collector, an internal electrode which encloses the internal current collector and is connected to one of the first pole terminal and the second pole terminal, an electrolyte portion which encloses the internal electrode, an external electrode which encloses the electrolyte portion and is connected the other one of the first pole terminal and the second pole terminal, an external current collector which encloses the external electrode, and a sheath portion which encloses the external current collector.

The body unit may comprise first and second current collectors which are isolated from each other and are disposed in parallel with each other, a first electrode which encloses the first current collector and is connected to one of the first pole terminal and the second pole terminal, a second electrode which encloses the second current collector and is connected to the other one of the first pole terminal and the second pole terminal, an electrolyte portion which encloses both the first electrode and the second electrode and isolates the first electrode and the second electrode from each other, and a sheath portion which encloses the electrolyte portion.

The first pole terminal and the second pole terminal may have different colors.

One end of the body unit at which the first pole terminal is formed and the other end of the body unit at which the second pole terminal is formed may have different colors.

According to another aspect of the present invention, there is provided a connector which connects the batteries described above in series or in parallel.

According to still another aspect of the present invention, there is provided a connector comprising a first connecting portion to which a first thread-type flexible battery is connectable, and a second connecting portion to which a second thread-type flexible battery is connectable, wherein each of the first connecting portion and the second connecting portion is a protrusive type so as to be insertable into a terminal of a battery or a slip-in type so as to allow a terminal of a battery to be inserted.

One of the first and the second connecting portions that is the protrusive type may comprise at least one convexo-concave portion formed on a protruding portion.

One of the first and the second connecting portions that is the slip-in type may comprise a fixing portion to fix an inserted terminal.

At least one of the first and the second connecting portions may comprise a plurality of connecting portions.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects of the invention will become and more readily appreciated from the following description of the exemplary embodiments, taken in conjunction with the accompanying drawings of which:

FIG. 1 is a view illustrating a thread-type battery according to an exemplary embodiment;

FIG. 2 is a view illustrating a thread-type battery according to another exemplary embodiment;

FIG. 3 is a view illustrating a thread-type battery according to still another exemplary embodiment;

FIG. 4 is a view illustrating the thread-type batteries of FIG. 1 connected to one another;

FIGS. 5 and 6 are views to explain a method of connecting a plurality of batteries using a connector according to an exemplary embodiment;

FIG. 7 is a view illustrating an example of a connector through which thread-type batteries are connected to one another according to another exemplary embodiment;

FIG. 8 is a view to explain a method of connecting batteries to the connector of FIG. 7;

FIGS. 9 and 10 are views illustrating a connector according to various exemplary embodiments;

FIG. 11 is a view to explain a method of connecting a plurality of thread-type batteries using the connectors of FIGS. 9 and 10;

FIG. 12 is a view to explain a method of connecting a plurality of thread-type batteries using a connector according to still another exemplary embodiment;

FIG. 13 is a view illustrating an example of a fabric structure formed using a plurality of thread-type batteries;

FIG. 14 is a view illustrating an example of an inner structure of a thread-type battery according to an exemplary embodiment;

FIG. 15 is a view illustrating an example of opposite poles of the thread-type battery according to an exemplary embodiment;

FIG. 16 is a view illustrating another example of an inner structure of the thread-type battery according to an exemplary embodiment;

FIG. 17 is a view illustrating an example of opposite poles of the thread type battery of FIG. 16;

FIG. 18 is a view illustrating an inner structure of a thread-type battery according to another exemplary embodiment;

FIG. 19 is a view illustrating an inner structure of a thread type battery according to another exemplary embodiment;

FIG. 20 is a view illustrating a detailed structure of a connector according to another exemplary embodiment;

FIG. 21 is a view to explain a detailed operation of a negative pole terminal connecting portion of the connector of FIG. 20; and

FIG. 22 is a view illustrating an inner structure of a connector according to another exemplary embodiment.

### DETAILED DESCRIPTION OF EXEMPLARY EMBODIMENTS OF THE INVENTION

Reference will now be made in detail to the present exemplary embodiments of the present invention, examples of which are illustrated in the accompanying drawings, wherein like reference numerals refer to the like elements throughout. The exemplary embodiments are described below in order to explain the present invention by referring to the figures.

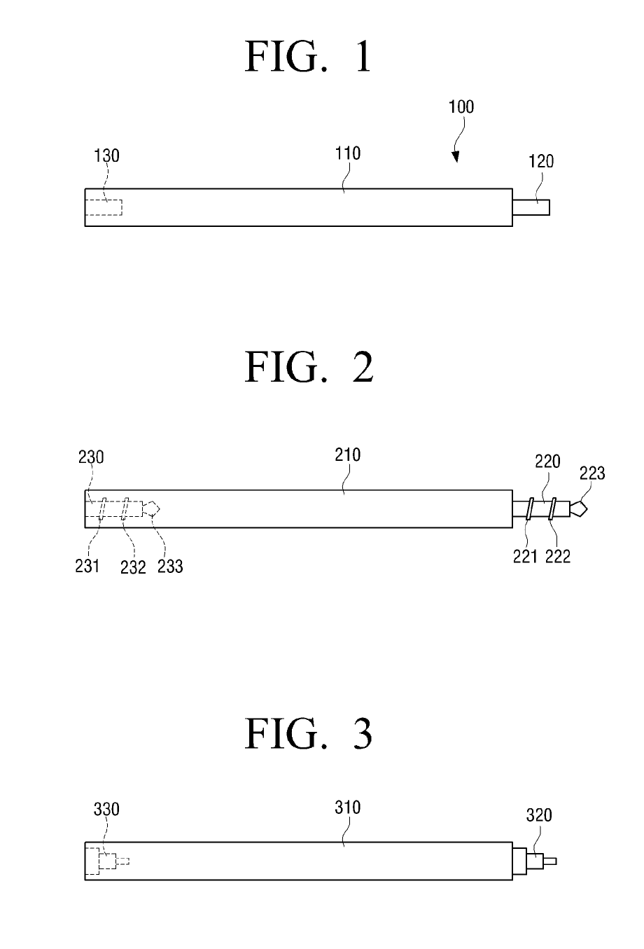

FIG. 1 is a view illustrating a thread-type battery according to an exemplary embodiment. Referring to FIG. 1, a thread-type battery comprises a body unit 110, a first pole terminal 120, and a second pole terminal 130.

The body unit 110 has a thread form and has flexibility. The thread form recited herein refers to a form that has various cross-sections such as a cylinder or a rectangular parallelepiped and also is thin and long such that a thing having the form can be bent or curved. Accordingly, the body unit 110 may be bent if it is subjected to a force. The thread-type battery may be called a wire-type battery, a line-type battery or other names.

The battery of the present exemplary embodiment may have various diameters and lengths. In this case, the battery may have a suitable diameter to be woven into a fabric structure. For example, the battery may have a diameter about from 0.1 mm to 3 mm. The length of the battery may be greater than the diameter. For example, the battery may be 10 cm long. The upper limit and the lowest limit of the diameter and the length may be changed variously according to a purpose and a field of the battery.

The body unit 110 comprises a positive electrode and a negative electrode therein and the two electrodes are distinguished from each other by an electrolyte. An inner structure of the body unit 110 will be explained in detail below.

The body unit 110 has the first pole terminal 120 formed at one end and the second pole terminal 130 formed at the other side. The first pole terminal 120 and the second pole terminal 130 have different polarities. In other words, if the first pole terminal 120 is a positive pole, the second pole terminal 130 is a negative pole.

In FIG. 1, the first pole terminal 120 protrudes from the body unit 110. The second pole terminal 130 is formed in a shape such that an external terminal is inserted into the body unit 110.

Accordingly, the first pole terminal 120 may be inserted into an external terminal having the same form as that of the second pole terminal 130 and an external terminal having the same form as that of the first pole terminal 120 may be inserted into the second pole terminal 130. As a result, users can easily recognize that a protrusive portion is a positive pole and an opposite portion is a negative pole and can connect the first pole terminal 120 or the second pole terminal 130 to another battery or another electronic device.

FIG. 2 is a view illustrating a battery according to another exemplary embodiment. Referring to FIG. 2, a first pole terminal 220 formed at one end of a body unit 210 has convexo-concave portions 221, 222 thereon. An end portion 223 of the first pole terminal 220 may be formed in a specific shape. The specific shape of the end portion 223 and the convexo-concave portions 221, 222 serve to prevent the first pole terminal 220 from slipping out of an external terminal easily. Although the two convexo-concave portions 221, 222 are illustrated in FIG. 2, the number, the location, and the shape of the convexo-concave portions may be changed diversely.

A second pole terminal 230 is formed in a shape such that an external terminal having the same shape as that of the first pole terminal 220 is inserted into the second pole terminal 230. As such, the first pole terminal 220 and the second pole terminal 230 may correspond to each other in their shapes.

FIG. 3 is a view illustrating a battery according to still another exemplary embodiment. Referring to FIG. 2, a first pole terminal 320 formed at one end of a body unit 310 may have a stepwise shape in which a plurality of layers are formed. Also, a second pole terminal 330 may be formed in a shape such that an external terminal having the same shape as that of the first pole terminal 320 is inserted into the second pole terminal 330.

As shown in FIGS. 2 and 3, the first pole terminal 320 and the second pole terminal 330 may be formed in various shapes so that the first pole terminal 320 and the second pole terminal 330 can be prevented from slipping out of another battery or another connector to which the first and the second pole terminals 320, 330 are connected.

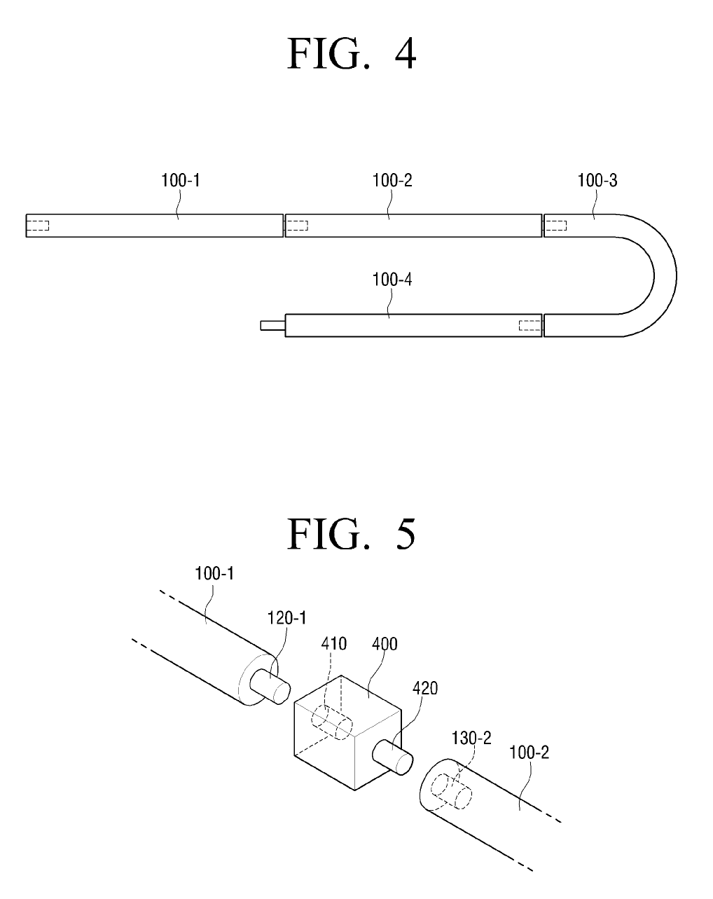

FIG. 4 is a view illustrating the batteries of FIG. 1 which are connected to one another. As shown in FIG. 4, if a plurality of thread-type batteries 100-1˜100-4 are used, the batteries can be used as a single long thread since each battery has flexibility. In other words, the batteries connected as shown in FIG. 4 may be twisted such that the batteries are used in the form of a rope. Also, the batteries are woven such that the batteries are used in the form of a fabric.

The batteries may be connected to one another directly or via a connector.

FIG. 5 is a view illustrating a connector according to an exemplary embodiment. Referring to FIG. 5, a connector 400 comprises a first connecting portion 410 formed at one side and a second connecting portion 420 formed at the other side. The first connecting portion 410 and the second connecting portion 420 are connected to each other in the connector 400 through conductive material. Accordingly, if one battery 100-1 is connected to the first connecting portion 410 and another battery 100-2 is connected to the second connecting portion 420, the two batteries 100-1, 100-2 are connected to each other in series.

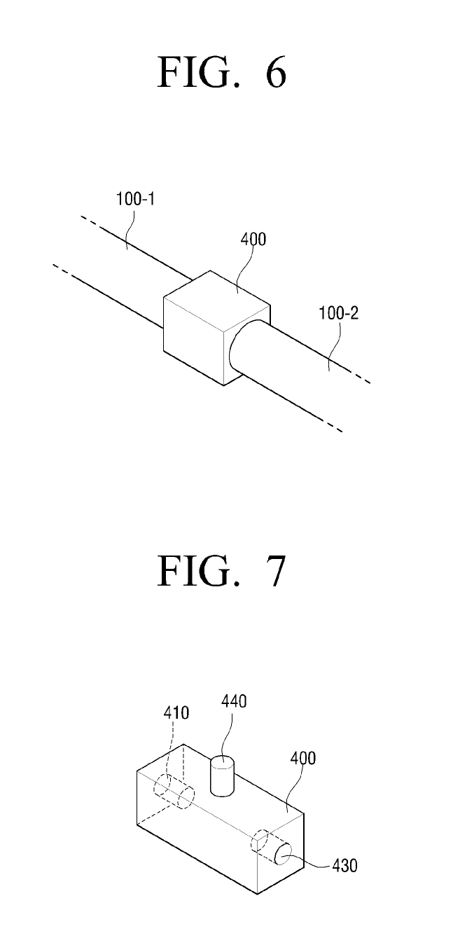

FIG. 6 is a view illustrating the two batteries 100-1, 100-2 connected to each other in series using the connector 400 of FIG. 5.

In FIGS. 5 and 6, only one first connecting portion 410 and one second connecting portion 420 are illustrated, but a plurality of first connecting portions 410 and a plurality of second connecting portions 420 may be formed according to another exemplary embodiment.

FIG. 7 is a view illustrating a connector according to another exemplary embodiment. Referring to FIG. 7, a connector 400 comprises two slip-in connecting portions 410, 430 and a protrusive connecting portion 440.

Accordingly, first pole terminals of two batteries are connected to each other in parallel via the two connecting portions 410, 430, and a second pole terminal of another battery is connected in series via the protrusive connecting portion 440.

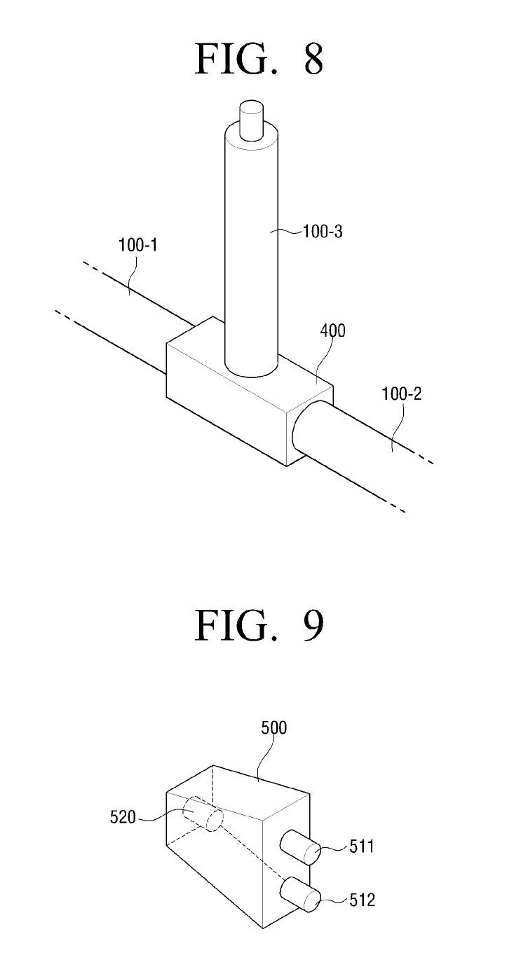

FIG. 8 is a view illustrating three batteries 100-1, 100-2, 100-3 connected to one another using the connector 400 of FIG. 7.

FIG. 9 is a view illustrating a connector 500 according to still another exemplary embodiment. Referring to FIG. 9, the connector 500 comprises two protrusive connecting portions 511, 512 and one slip-in connecting portion 520.

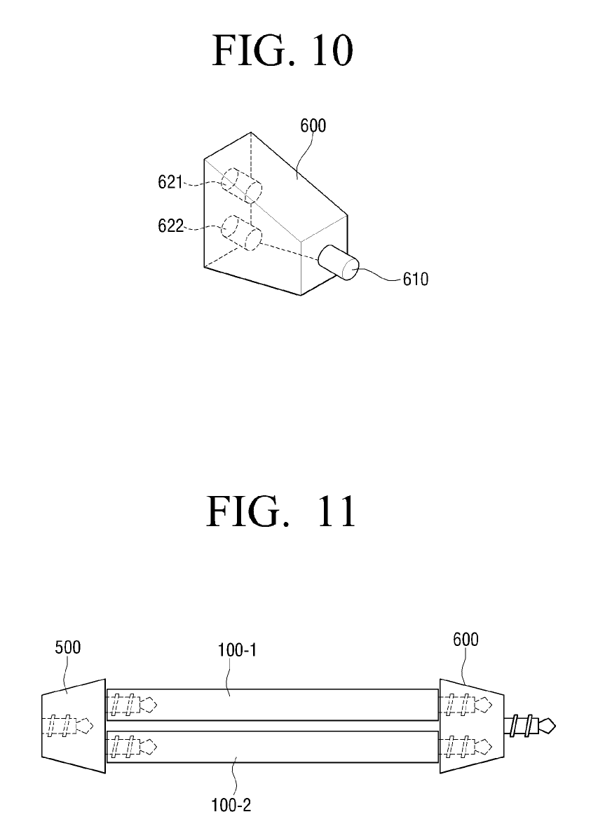

FIG. 10 is a view illustrating a connector 600 according to still another exemplary embodiment. Referring to FIG. 10, the connector 600 comprises one protrusive connecting portion 610 and two slip-in connecting portions 621, 622.

Each connecting portion illustrated in FIGS. 9 and 10 has a cylindrical shape as that of the terminal of FIG. 1. However, the connecting portion may have a convexo-concave portion or may have a stepwise shape as shown in FIGS. 2 and 3.

FIG. 11 is a view to explain a method of connecting two batteries in parallel using the connectors 500, 600 of FIGS. 9 and 10, which have convexo-concave portions formed on each connecting portion.

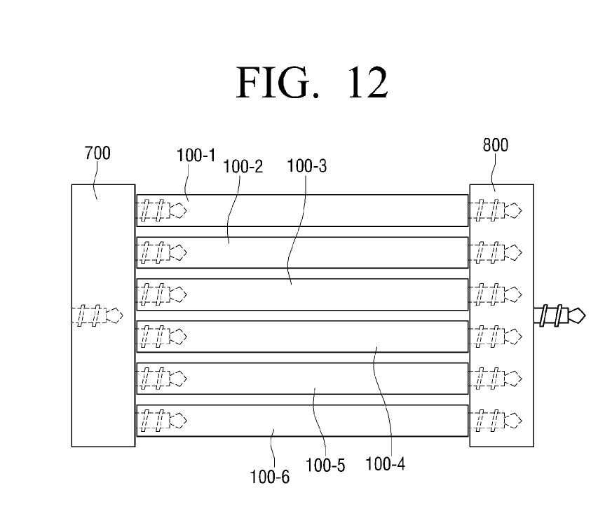

FIG. 12 is a view to explain a method of connecting two or more batteries in parallel and corresponding shapes of connectors 700, 800. In FIG. 12, six batteries 100-1˜100-6 in total are connected to one another in parallel via two connectors 700, 800.

To achieve this, each connector 700, 800 of FIG. 12 may comprise a plurality of connecting portions of various shapes.

As described above, the number and the shapes of the connecting portions provided on the connectors may be realized diversely. An interior of the connector is filled with conductive material so that the first connecting portion and the second connecting portion are electrically connected to each other.

In the above-described embodiments, the connector has an angled exterior. However, this should not be considered as limiting. The connector may have a cylindrical shape.

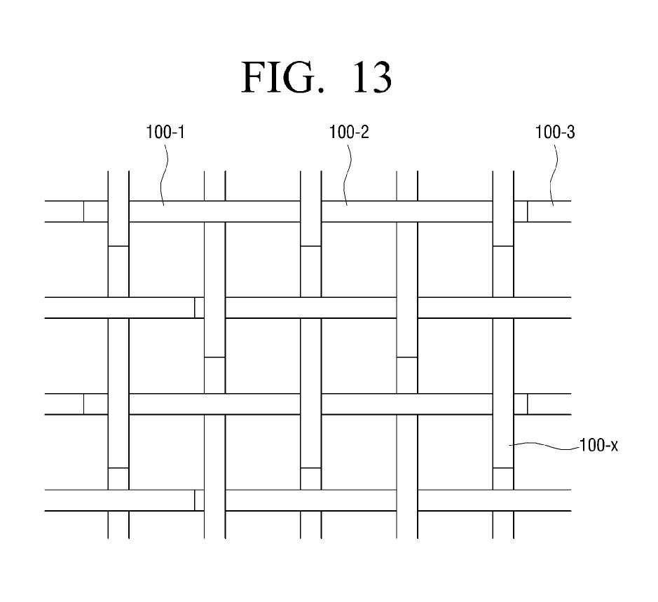

FIG. 13 is a view illustrating a fabric structure which is woven from a plurality of thread-type batteries 100-1, 100-2, 100-3˜100-x connected to one another as a thread. The fabric structure of FIG. 13 may be used to realize a clothing type electronic product. In other words, instead of putting an electronic product in a general fabric and mounting a corresponding battery pack, a fabric itself is used as a battery so that a clothing type electronic product can be used without a battery pack.

In FIG. 13, only the connection between the batteries is illustrated, but, the batteries may be connected using various connectors as described above in various ways and accordingly fabric structures of various forms may be made.

Accordingly, the battery according to exemplary embodiments may have various shapes such as a one-dimensional thread shape, a two-dimensional fabric shape, or a three-dimensional clothing, shoe, tent, hat, or belt shape.

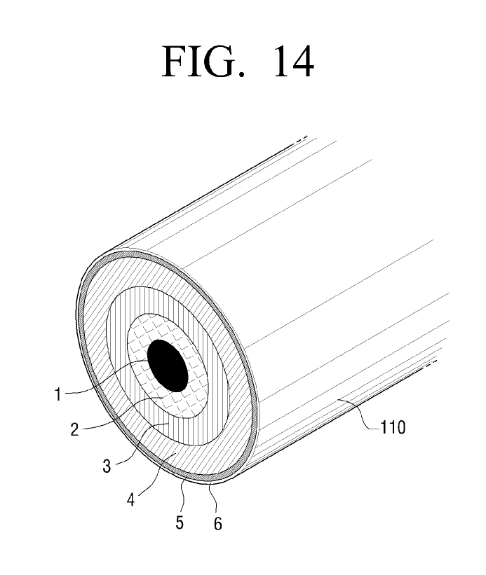

FIG. 14 is a cross-section view illustrating an inner structure of a thread-type battery according to an exemplary embodiment. Referring to FIG. 14, a body unit 110 comprises an internal current collector 1, an internal electrode 2, an electrolyte portion 3, an external electrode 4, an external current collector 5, and a sheath portion 6, which are formed from the inside in sequence.

The internal current collector 1 may be made of TiNi type alloys having high elasticity, pure metals such as copper or aluminum, pure meal coated with carbon, conductive material such as carbon and carbon fiber, or conducting polymer such as polypyrrole.

A surface of the internal current collector 1 is covered by the internal electrode 2. The internal electrode 2 is formed on the internal current collector 1 in various ways such as slurry coating and spraying using powder or active material, hot dip plating, vacuum evaporation, sputtering, ion plating, molecular beam epitaxy, chemical vapor deposition using heat, light and plasma, a dry method using a clad layer, a wet method using an electrochemical reaction, and other pasting techniques.

The internal electrode 2 is made of various materials according to its electrode characteristic. The internal electrode 2 has a polarity opposite that of the external electrode 4. Accordingly, if the internal electrode 2 is a negative electrode, the external electrode 4 is a positive electrode. If the internal electrode 2 is a positive electrode, the external electrode 4 is a negative electrode.

If the internal electrode 2 is the negative electrode, the internal electrode 2 may be made of negative electrode material, for example, metals such as lithium, natrium, zinc, magnesium, cadmium, metallic alloy for hydrogen storage, and lead, nonmetals such as carbon, or polymer electrode material such as organic sulfur. In this case, since the external electrode 4 is used as the positive electrode, the external electrode 4 is made of positive electrode material, for example, sulfur and metal sulfide, lithium transition metal oxide such as LiCoO₂, SOCI₂, MnO₂, Ag₂O, Cl₂, NiCl₂, NiOOH, or a polymer electrode. If the internal electrode 2 is used as the positive electrode and the external electrode 4 is used as the negative electrode, the reverse applies.

A surface of the internal electrode 2 is covered by the electrolyte portion 3. The electrolyte portion 4 physically isolates the internal electrode 2 and the external electrode 4 from each other and enables ion exchange between the internal electrode 2 and the external electrode 4. The electrolyte portion 3 may be made of a polymer electrolyte of a gel type using PEO, PVdF, PMMA, or PVAC, a solid type, or a porous type, or a sulfide, LiPON, or oxide-based solid electrolyte.

As described above, the external electrode 4 is formed outside the electrolyte portion 3 and the external current collector 5 is formed outside the external electrode 4. The external current collector 5 may be made of various materials as those of the internal current collector 1.

The sheath portion 6 is formed outside the external current collector 5. The sheath portion 6 may use general polymer resin. For example, PVC, HDPE, or epoxy resin may be used. Besides these, any material that can prevent damage to the thread-type battery and can be freely bent or curved may be used for the sheath portion 6.

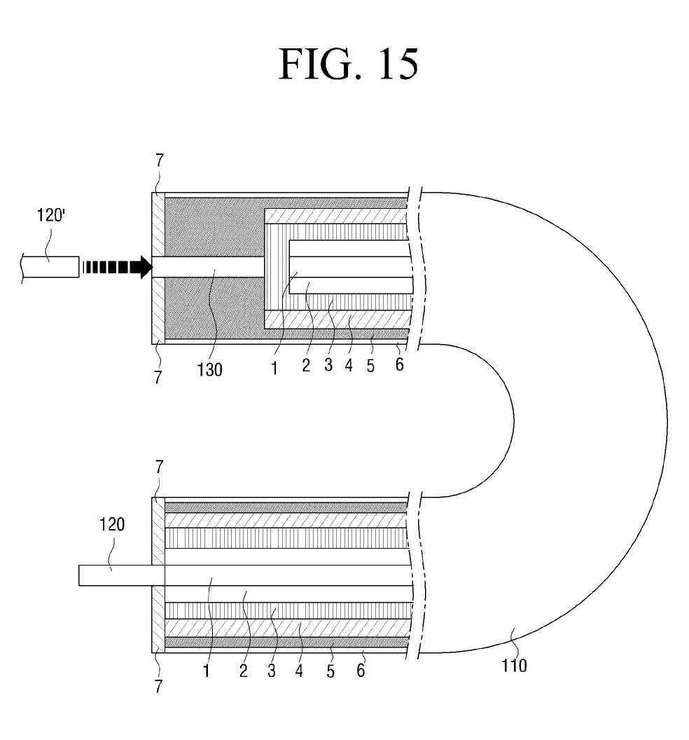

FIG. 15 is a view illustrating opposite terminals of the battery having the inner structure of FIG. 14. Referring to FIG. 15, a first pole terminal 120 is a portion extending from the internal current collector 1 to the outside of the body unit 110. On the other hand, a second pole terminal 130 is formed in a shape such that a first pole terminal 120′ of another battery is inserted. In this case, the inserted external terminal 120′ is in contact with the external current collector 5 inside the body unit 110 and is isolated from the internal electrode 2 or the internal current collector 1 due to the presence of the electrolyte portion 3. The opposite ends of the battery are processed with finishing material so that the internal current collector 1, the internal electrode 2, the electrolyte portion 3, the external electrode 4, and the external current collector 5 are not exposed to the outside.

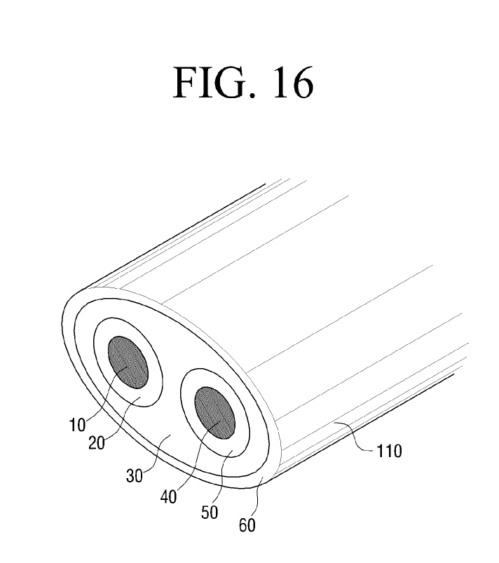

FIG. 16 is a view illustrating an inner structure of a battery according to another exemplary embodiment. Referring to FIG. 16, a first current collector 10 and a second current collector 40 are isolated from each other and are disposed in parallel with each other. The first current collector 10 is enclosed by a first electrode 20 and the second current collector 40 is enclosed by a second electrode 50. Accordingly, the first and the second electrodes 20, 50 are isolated from each other and are disposed in parallel with each other.

The first and the second electrodes 20, 50 are enclosed by an electrolyte portion 30. The electrolyte portion 30 supports ion exchange between the first and the second electrodes 20, 50 and physically isolates the first and the second electrodes 20, 50 from each other. The electrolyte portion 30 is enclosed by a sheath portion 60.

The current collectors 10, 40, the electrodes 20, 50, the electrolyte portion 30, and the sheath portion 60 of FIG. 16 may be made of various materials as the current collectors, the electrodes, the electrolyte portion, and the sheath portion of FIG. 14.

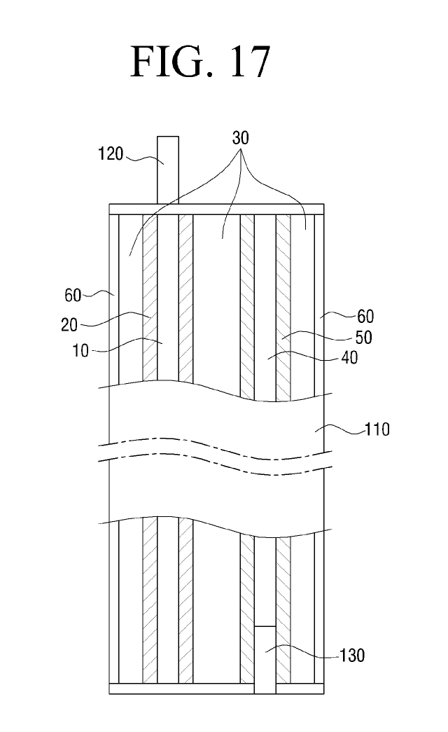

FIG. 17 is a view illustrating the inner structure of the battery of FIG. 16. Referring to FIG. 17, a first pole terminal 120 may be a portion extending from the first current collector 10 and protruding to the outside. On the other hand, a second pole terminal 130 may be a depression portion in the second current collector 40. A plurality of batteries are connected to one another via the first pole terminal 120 and the second pole terminal 130.

Although only the two electrodes are provided in FIG. 17, three or more electrodes may be provided in one battery.

Also, in the above embodiments, the first pole terminal and the second pole terminal are recognized as a positive pole or a negative pole according to their respective shapes, i.e., whether they are a protrusive type or a slip-in type. However, the first pole terminal and the second pole terminal may be distinguished by colors.

In other words, the first pole terminal protruding to the outside is colored red and the second pole terminal is colored blue so that the positive pole and the negative pole can be more easily distinguished from each other.

In this case, materials of the first pole terminal and the second pole terminal may be selected among a plurality of metals in consideration of colors. For example, if the first pole terminal is the positive pole, the first pole terminal may be made of Al. On the other hand, the second pole terminal may be made of Cu. Otherwise, the first pole terminal may be made of Cu, and the second pole terminal may be made of Al.

Accordingly, the first pole terminal and the second pole terminal may be distinguished from each other by their respective colors, even if extra coloring is not processed. The materials of the pole terminals are not limited and may be set diversely.

Also, the body unit of the first pole terminal may be enclosed by a red sheath, whereas the body unit of the second pole terminal may be enclosed by a blue sheath. Accordingly, the user can distinguish between the positive pole and the negative pole of the thread-type battery and thus user's convenience can be improved.

Also, although the body unit of the thread-type battery has a cylindrical shape in the above embodiments, the cross-section of the body unit may be an oval, a quadrilateral or other polygon.

FIG. 18 is a view illustrating a cross-section of a thread-type battery which is formed in a quadrilateral shape. In this case, a bending directivity of the thread-type battery is limited to four directions, the north, south, east and south directions. Accordingly, the thread-type battery can be prevented from being twisted.

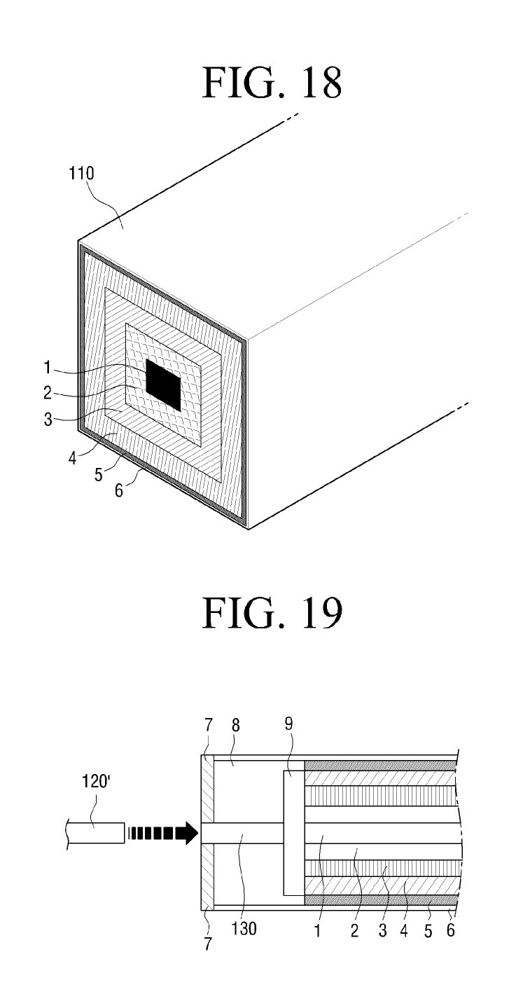

FIG. 19 is a view illustrating an inner structure of a thread-type battery according to still another exemplary embodiment. Referring to FIG. 19, a portion of a body unit 110 at which a second pole terminal 130 is formed is filled with conductive material 8 which is electrically connected to an external current collector 5. Accordingly, if an external terminal 120′ is inserted, the external terminal 120′ is electrically connected to the external current collector 5. In this case, the thread-type battery may further comprise an isolation membrane 9 to prevent the external terminal 120′ from contacting an external electrode 4, an electrolyte portion 3, an internal electrode 2 and an internal current collector 1.

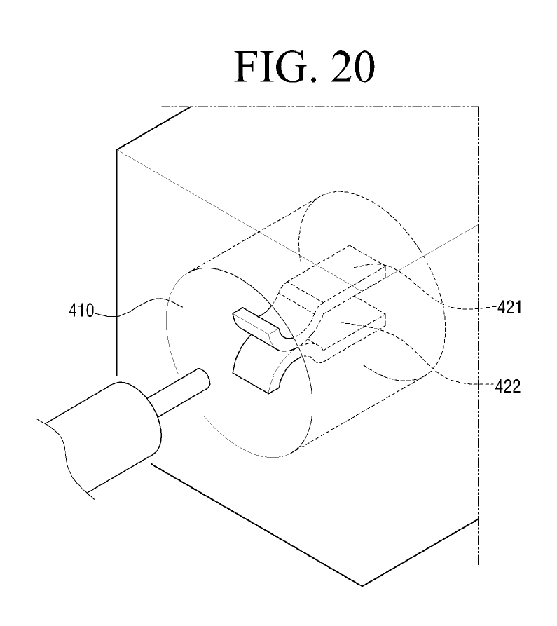

FIG. 20 is a view illustrating a connector 400 according to another exemplary embodiment. Referring to FIG. 20, fixing portions 421, 422 are formed in a first connecting portion 410 to fix an external terminal which is inserted into the first connecting portion 410.

The fixing portions 421, 422 are made of material having constant elasticity and are formed in pair to face each other.

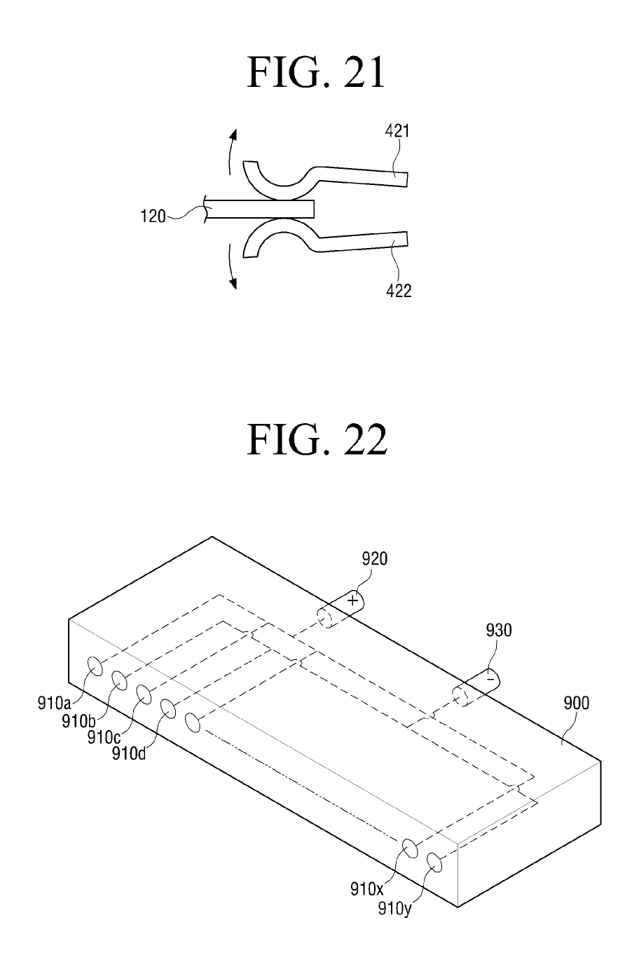

FIG. 21 is a view to explain operations of the fixing portions 421, 422. As shown in FIG. 21, if an external terminal is inserted between the fixing portions 421, 422, the fixing portions 421, 422 are splayed in arrow directions such that the external terminal is fixed due to an elastic force.

Since the thread-type battery described in the above embodiments has a small size and flexibility, it may be difficult to insert a protrusive pole terminal into a slip-in pole terminal. However, if the fixing portions 421, 422 are provided in the hole 410 having a predetermined size as shown in FIG. 20, the terminals can be automatically fixed simply by being inserted. Therefore, user's convenience can be improved.

The fixing portions 421, 422 shown in FIG. 21 may be applied to the connectors of FIGS. 5 to 12 according to the various exemplary embodiments.

Also, in the above-described thread-type battery, the protrusive terminal is a positive pole and the slip-in terminal is a negative pole. However, this should not be considered as limiting. The protrusive terminal may be a negative pole. In other words, both a first type battery in which a protrusive terminal is a positive pole and a second type battery in which a protrusive terminal is a negative pole may be used. In this case, a connector may comprise only a slip-in connecting portion rather than comprising a protrusive connecting portion and a slip-in connecting portion as shown in FIG. 4. In this case, the fixing portions 421, 422 may be provided in each connecting portion.

FIG. 22 is a view illustrating a connector 900 which combines the first type battery and the second type battery according to still another exemplary embodiment.

Referring to FIG. 22, the connector 900 comprises a plurality of connecting portions 910a to 910y into which an external terminal is inserted. The first type battery and the second type battery may be connected to the connecting portions. Specifically, a positive pole protrusive terminal is inserted into the connecting portions 910a, 910c, . . . , 910x, and a negative pole protrusive terminal is inserted into the connecting portions 910b, 910d, . . . , 910y.

The connecting portions into which the positive pole terminal is inserted are connected to a positive pole protrusive terminal 920 via an internal wire, and the connecting portions into which the negative pole terminal is inserted are connected to a negative pole protrusive terminal 930 via an internal wire.

The connector 900 shown in FIG. 22 may be connected to ends of batteries which are woven in a fabric structure as shown in FIG. 13 to connect the batteries to an external device.

The battery described above is not limited to a secondary battery. In other words, the battery may be a primary battery or a solar battery. In particular, in the case of a solar battery, the sheath portion may be made of transparent material in order to realize the solar battery as a thread-type battery.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A thread-type battery comprising;
a flexible body unit;
a first pole terminal which is formed at one end of the body unit and protrudes so as to be insertable into a first external terminal; and
a second pole terminal which is formed at the other end of the body unit and has a shape in which a second external terminal is to be inserted, and which has an polarity opposite a polarity of the first pole terminal.

2. The thread-type battery as claimed in claim 1, wherein the first pole terminal has at least one convexo-concave portion formed thereon.

3. The thread-type battery as claimed in claim 2, wherein the second pole terminal has a shape in which a second terminal corresponding to the first pole terminal in shape is to be inserted.

4. The thread-type battery as claimed in claim 1, wherein the body unit comprises:
an internal current collector;
an internal electrode which encloses the internal current collector and is connected to one of the first pole terminal and the second pole terminal;
an electrolyte portion which encloses the internal electrode;
an external electrode which encloses the electrolyte portion and is connected the other one of the first pole terminal and the second pole terminal;
an external current collector which encloses the external electrode; and
a sheath portion which encloses the external current collector.

5. The thread-type battery as claimed in claim 1, wherein the body unit comprises:
first and second current collectors which are isolated from each other and are disposed in parallel with each other;
a first electrode which encloses the first current collector and is connected to one of the first pole terminal and the second pole terminal;
a second electrode which encloses the second current collector and is connected to the other one of the first pole terminal and the second pole terminal;
an electrolyte portion which encloses both the first electrode and the second electrode and isolates the first electrode and the second electrode from each other; and
a sheath portion which encloses the electrolyte portion.

6. The thread-type battery as claimed in claim 1, wherein the first pole terminal and the second pole terminal have different colors.

7. The thread-type battery as claimed in claim 1, wherein one end of the body unit at which the first pole terminal is formed and the other end of the body unit at which the second pole terminal is formed have different colors.

8. The thread-type battery as claimed in claim 1, wherein one of the first pole terminal and the second pole terminal is made of Al and the other one is made of Cu.

9. A connector which connects a plurality of batteries according to any one of claims 1 to 8 in series or in parallel.

10. A connector comprising:
a first connecting portion to which a first thread-type flexible battery is connectable; and
a second connecting portion to which a second thread-type flexible battery is connectable,
wherein each of the first connecting portion and the second connecting portion is a protrusive type so as to be insertable into a terminal of a battery or a slip-in type so as to allow a terminal of a battery to be inserted.

11. The connector as claimed in claim 10, wherein one of the first and the second connecting portions that is the protrusive type comprises at least one convexo-concave portion formed on a protruding portion.

12. The connector as claimed in claim 10, wherein one of the first and the second connecting portions that is the slip-in type comprises a fixing portion to fix an inserted terminal.

13. The connector as claimed in claim 10, wherein at least one of the first and the second connecting portions comprises a plurality of connecting portions.
